(19) United States
(12) Patent Application Publication
(10) Pub. No.: US 2011/0319157 A1
(43) Pub. Date: Dec. 29, 2011

(54) GAMING POINT EXCHANGE SYSTEM AND METHOD

(76) Inventor: Yury Kuznetsov, Glendale, CA (US)

(21) Appl. No.: 12/823,840

(22) Filed: Jun. 25, 2010

(51) Int. Cl. G06F 17/00

(52) U.S. Cl. 463/25; 463/1

(57) ABSTRACT

A gaming system, a gaming market, and a method, is disclosed. The gaming system may include two or more games to be played by one or more players. Each game may be configured to enumerate a number of points earned through play of the respective two or more games. The system may also include two or more exchangeable gaming currencies. Each gaming currency may be convertible to, and convertible from, universal points using respective two or more conversion factors. The two or more exchangeable gaming currencies may be at least two of: the points earned through play of a first of the two or more games, the points earned through play of a second of the two or more games, and commonly recognized monetary units.

### BACKGROUND

This application relates generally to gaming systems. More specifically, this application relates to a system, a gaming market, and a method to enable players to exchange points earned in one game, for points from another game, and/or to exchange currency for points, and/or points for currency.

### BACKGROUND AND SUMMARY

Currently games, such as computer games, are played by millions of people. But the value of earning points playing one game is not easily, or objectively, comparable to the value of earning points playing another game. Further, there is no intrinsic way to measure the accomplishment of earning a particular number of points in any given game. In addition, the fun and satisfaction of playing games may become diminished through just accumulating points in one game, and then starting over again from a zero point total in another game. Starting a new game without any points at all can be dissatisfying for some players. In addition, game creators must sometimes start essentially from scratch marketing a new game despite enjoying market success with one or more earlier games.

Therefore, there is a significant need for an objective way to compare the value of points earned playing one game to the points earned playing another. Further there is a significant need to objectively measure an intrinsic value of point totals. There is also a need to link, and carry over, the accomplishments of one game to another game. There is also a need to enable a new player to begin play with some points gotten through some type of payment. There is a still further need to leverage the marketing of one game using the popularity of another game. These and other needs may be addressed by one or more embodiments according to the current disclosure.

This application discloses a gaming system, a gaming market, and a method that is economical to produce, of simple implementation, and capable of mass production, but also capable of providing a user a more satisfying gaming experience, and of providing game creators a more robust gaming market.

In particular, this application discloses a gaming system including two or more games to be played by one or more players. Each game may be configured to enumerate a number of points earned through play of the respective two or more games. The system may also include two or more exchangeable gaming currencies. Each gaming currency may be convertible to, and convertible from, universal points using respective two or more conversion factors. The two or more exchangeable gaming currencies may be at least two of: the points earned through play of a first of the two or more games, the points earned through play of a second of the two or more games, and commonly recognized monetary units.

This application also discloses a computer enabled gaming market. The gaming market may include two or more games to be played by one or more players. Each game may be configured to enumerate a number of points earned through play of the respective two or more games. Points of one of the two or more games may be exchangeable for one or both of: commonly recognized monetary units, or equivalent points wherein the equivalent points are considered equivalent in value in the gaming market as if they were earned through play of another of the two or more games.

Various operations may be described as multiple discrete operations in turn, in a manner that may be helpful in understanding embodiments of the present invention; however, the order of description should not be necessarily be construed to imply that these operations are order dependent.

Finally, this application discloses a method of forming a gaming system. The method may include providing two or more games to be played. The two or more games may be configured such that players of any of the two or more games can earn points for completing predetermined actions while playing one or more of the two or more games. The method may also include facilitating an exchange between a first player of at least one of the two or more games and one or both of a gaming system administrator and a second player, wherein the exchange includes exchanging one or both of: commonly recognized monetary units, and points earned through play of one of the two or more games, or equivalent points wherein the equivalent points are considered equivalent in value in the gaming system as if they were earned through play of another of the two or more games.

Embodiments may provide an exchange system for buying, selling, and trading points that may be earned from a plurality of games. The exchange system may offer points as a commodity to users for accomplishments achieved during the course of playing one or more games. The points may be treated as a commodity that has its own value. For example, a very popular game with great demand for the points may have a larger commodity value than an unpopular game with a low demand for the points from that game. The point totals may be the same, but their values as commodity may be much different. Therefore, embodiments may provide three potentials: buy, sell, and trade the points. In the trading process, there may be a conversion to equate the points so the trade may be of equal value. That value may be determined by the market created by the exchange system according to the present disclosure.

In one example embodiment, game points can be converted to universal points or vice versa. The gaming market may determine the true value of game points as related to a common, or universal, point. For example, 500,000 points from Game A, 1000 points from Game B, or 75,000 points from Game C, may all equal the same as 10,000 universal points. In this way, a user may better gauge his/her value in universal points. Also, this may give users the ability to “cash in” their points for universal points and buy game points from universal points, making it a different option than trading one game's points for another.

An administrator, or an Exchange, may charge fees for the trading of points. The Exchange may also accumulate a pool of points that may be bought or sold for real currency. The Exchange may receive a percentage fee, or commission, either in the form of points or real currency, per transaction.

### BRIEF DESCRIPTION OF THE DRAWINGS

The drawings, when considered in connection with the following description, are presented for the purpose of facilitating an understanding of the subject matter sought to be protected.

FIG. 1 is a schematic view illustrating an example system in accordance with the current disclosure;

FIG. 2 is a flow diagram illustrating an example method in accordance with the current disclosure;

FIG. 3 is a flow diagram illustrating another example method in accordance with the current disclosure;

FIG. 4 is a flow diagram illustrating another example method in accordance with the current disclosure; and

FIG. 4 is a flow diagram illustrating another example method in accordance with the current disclosure.

### DETAILED DESCRIPTION

While the present gaming system, gaming market, and methods are described with reference to several illustrative embodiments described herein, it should be clear that the present invention should not be limited to such embodiments. Therefore, the description of the embodiments provided herein is illustrative of the present invention and should not limit the scope of the invention as claimed. In addition, while the following description references drawings showing particular interconnections, item quantities, and arrangements, it will be appreciated that the invention may be configured to have other interconnections, item quantities, and arrangements.

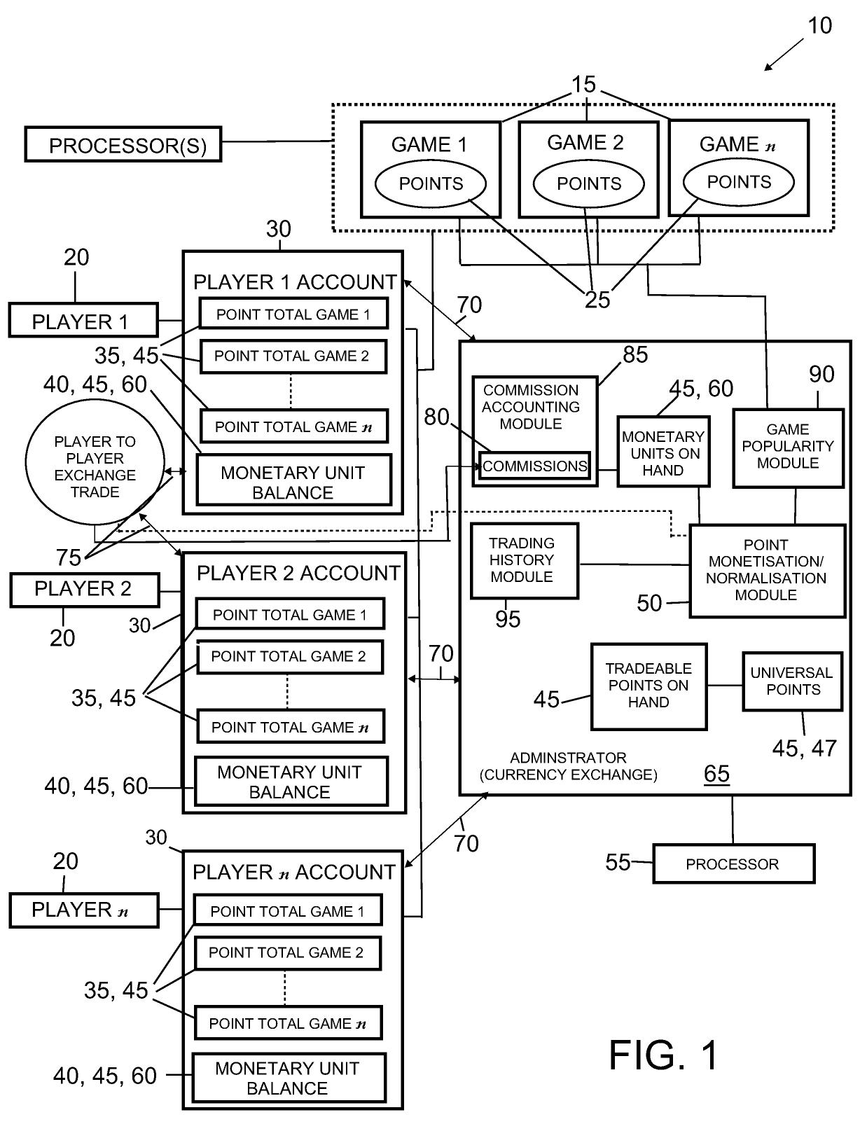

Referring now to FIG. 1, a schematic diagram of a first example embodiment of a gaming system 10 is disclosed. The gaming system 10 may include two or more games 15 to be played by one or more players 20. Each game 15 may be configured to enumerate a number of points 25 earned through play of the respective two or more games 15. Each of the one or more players 20 may have a player account 30 wherein point totals 35 of points accrued may be tabulated. In addition, the player account(s) 30 may also keep an account of a currency total 40, or monetary unit balance 40. The gaming system 10 may also include two or more exchangeable gaming currencies 45 each convertible to, and each convertible from, universal points 47 using respective two or more conversion factors. The two or more conversion factors may be determined by a point monetization/normalization module 50 which may be a software module that maybe executed by a computing device that may be, or may include, a processor 55. The two or more exchangeable gaming currencies 45 may be at least two of: the points 25 earned through play of a first of the two or more games 15, the points 25 earned through play of a second of the two or more games 15, and commonly recognized monetary units 60.

All or parts of the gaming system 10 may be computer and/or processor 55 enabled. The system 10 may be managed, or administered by an administrator 65 which may be, in some embodiments, be referred to as a currency exchange. The one or more players 20 may make a player to administrator trade 70 by exchanging points 25 earned while playing one of the two or more games 15. The gaming currencies 45 may be convertible to and from the universal points 47 during a player to administrator trade 70. The gaming currencies 45 may also be convertible to and from the universal points 47 during a player to player trade 75.

The one or more players 20 may also, or instead trade 70 commonly recognized monetary units 60 with the game, or system, administrator 65. The administrator 65 may be for example a company organized to manage, and/or execute, software, and/or firmware, and/or hardware configured to implement the system 10. The company may also manage and/or be the creators of the games 15. The system 10 may utilize the Internet, or other network, in order to interact with players 20.

A commission 80 may be charged to the one or more players 20 each time the two or more exchangeable gaming currencies 45 are converted from one form to another form, for example, each time points 25 earned through play of a first game 15 are converted to points 25 earned through play of a second of the two or more games 15, and/or to, or from, commonly recognized monetary units 60. A commission calculation, or accounting, module 85 may be configured to calculate, and/or keep an accounting of commissions to be charged to the one or more players 20 upon making a trade 70, 75. The commission 80 may be determined as a predetermined percentage of a universal value amount of the points 25. The commission 80, or fee, may be in the form of a percentage of points traded, or in the form of the commonly recognized monetary units 60. The commission 80 may be charged to one or both of the players 20.

The two or more conversion factors may be determined by predetermined gaming system market factors such as a relative popularity of each of the two or more games 15, or a trading history of points 25 from the one or more games 15. The relative popularity of the two or more games 15 may be determined by a game popularity module 90. The trading history of points traded from and to each of the various games, and monetary units traded into and from points from each of the various games may be monitored and/or tabulated by a trading history module 95.

According to various embodiments, a player may purchase universal points 47 using commonly recognized monetary units 60 to be added to the player's player account 30 and at a later time may convert the universal points 47 to equivalent points 15 for a particular game to be considered points as if they were earned through play of the particular game 15. The equivalent points 15 may then be held in the player's player account 30. In some embodiments a player may “cash out” and may receive a payment equivalent, or substantially equivalent, to his or her currency total 40.

The commonly recognized monetary units may be a government recognized monetary unit, such as US dollars, or Euros, or the like.

FIG. 1 also illustrates a computer, and/or or processor, enabled gaming market 10. The gaming market 10 may include two or more games 15 to be played by one or more players 20. Each game 15 may be configured to enumerate a number of points 25 earned through play of the respective two or more games 15. Points 25 of one of the two or more games 15 may be exchangeable for one or both of: commonly recognized monetary units 60, or equivalent points wherein the equivalent points are considered equivalent in value in the gaming market as if they were earned through play of another of the two or more games 15.

As discussed, each one of the two or more games 15 may be converted into universal points 25 using respective conversion factors. The points 25 of one of the two or more games 15 may be exchangeable between two players 20, or exchangeable between one player 20 and an administrator 65 of the gaming market 10. A commission 80 may be charged the one or more players each time points are exchanged. In some cases the commission is between 0.01% and 5.00%, for example. In some cases the commission 80 may be 1%. Other commission amounts are possible.

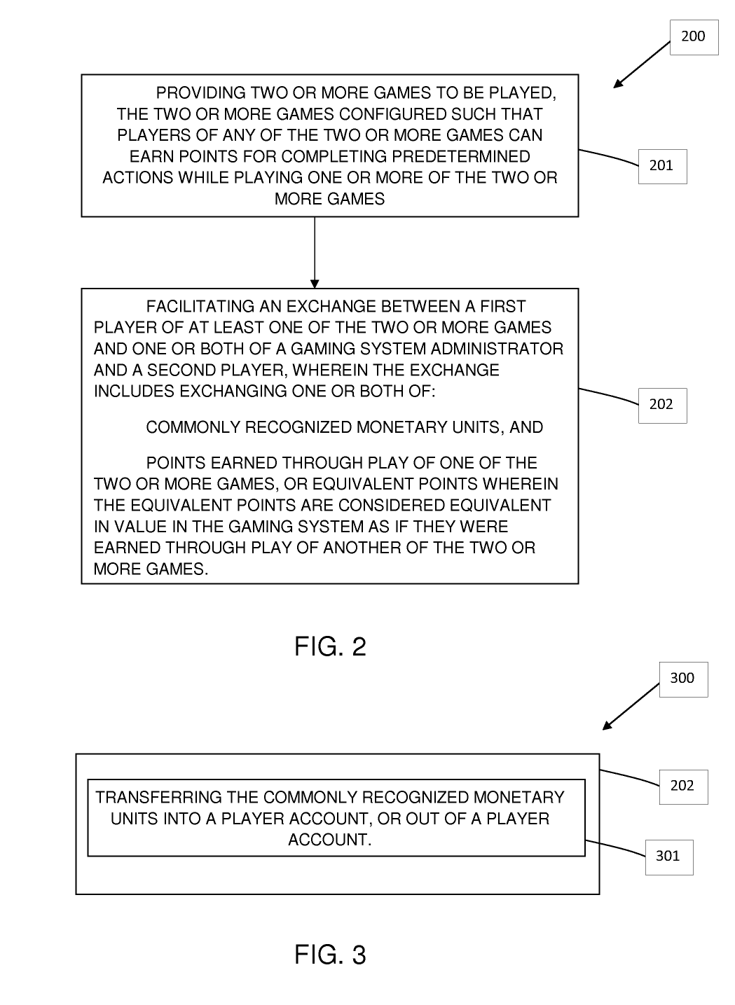

FIG. 2 is a flow diagram illustrating an example method 200 of forming a gaming system in accordance various possible embodiments with the present disclosure may provide a method of forming a gaming system. The method 200 may include, at 201, providing two or more games to be played, the two or more games may be configured such that players of any of the two or more games can earn points for completing predetermined actions while playing one or more of the two or more games, The method 200 may also include, at 202, facilitating an exchange between a first player of at least one of the two or more games and one or both of a gaming system administrator and a second player, wherein the exchange includes exchanging one or both of:
commonly recognized monetary units, and
points earned through play of one of the two or more games, or equivalent points wherein the equivalent points are considered equivalent in value in the gaming system as if they were earned through play of another of the two or more games.

In some cases the method 200 may be a computing device enabled method. The commonly recognized monetary units may be government recognized monetary units, such as US dollars, or Euros, or the like.

FIG. 3 is a flow diagram illustrating another example method 300, which may be a modification of the method 200 shown in FIG. 2. In the method 300 the facilitating an exchange at 202 in FIG. 2 may include, at 301, transferring the commonly recognized monetary units into a player account, or out of a player account.

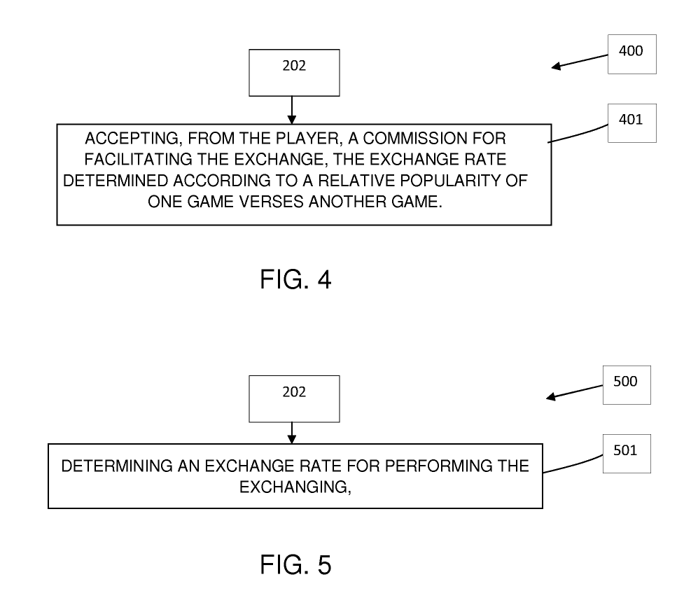

FIG. 4 is a flow diagram illustrating another example method 400, which may be a modification of the method 200 shown in FIG. 2. The method 400 may further include, at 401, accepting, from the player, a commission for facilitating the exchange.

FIG. 5 is a flow diagram illustrating another example method 500, which may be a modification of the method 200 shown in FIG. 2. The method 400 may further include, at 501, determining an exchange rate for performing the exchanging, the exchange rate may be determined according to a relative popularity of one game verses another game. The relative popularity may be a measure of how many times a first game is played relative to a second, or other, game played in the gaming system.

The methods described herein may include determining relative amounts of the points exchanged, or commonly recognized monetary units exchanged, by determining a relative popularity of the game from which the points were earned as compared to the game for which the points were traded.

Another example method may include performing a trade wherein the trade comprises: receiving from a user's account a quantity of trade-in points which may have been earned by the user through play of one or more recognized games, or receiving a value equal to a quantity of a currency from the user's account. The method may also include returning to the user's account, in exchange for the quantity of trade-in points, one or both of currency, or equivalent points. The equivalent points considered as if the equivalent points were earned through play of another game.

Another example method may include earning a quantity of points for one or more accomplishments achieved through play of a first game; and trading all or a portion of the quantity of points for equivalent points as if the equivalent points were earned through play of another game, and/or trading all or a portion of the quantity of points for a tradable currency.

The method may also include paying a commission to an administrator, or a market maker. The commission based on one or more of: the number of points traded from the game which the equivalent points were received, and the game from which the quantity of points were originally earned.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A gaming system comprising:
two or more games to be played by one or more players, each game configured to enumerate a number of points earned through play of the respective two or more games; and
two or more exchangeable gaming currencies each convertible to, and each convertible from, universal points using respective two or more conversion factors;
the two or more exchangeable gaming currencies being at least two of:
the points earned through play of a first of the two or more games,
the points earned through play of a second of the two or more games, and commonly recognized monetary units.

2. The gaming system of claim 1, wherein the gaming system is computer enabled.

3. The gaming system of claim 1, wherein two players can make a player to player trade by exchanging points from one of the two or more games for points from another of the two or more games using one of the two or more conversion factors, and wherein a fee in the form of a percentage of points traded, or in the form of the commonly recognized monetary units, is charged to one or both of the players.

4. The gaming system of claim 1, wherein a player can make a player to administrator trade by exchanging points earned while playing one of the two or more games, or commonly recognized monetary units with a game administrator.

5. The gaming system of claim 1, including player accounts, and wherein a player can purchase universal points using commonly recognized monetary units to be added to the player's player account and at a later time convert the universal points to equivalent points for a particular game to be considered points as if they were earned through play of the particular game, and wherein the equivalent points are held in the player's player account.

6. The gaming system of claim 1, wherein the two or more conversion factors are determined by predetermined gaming system market factors.

7. The gaming system of claim 6, wherein the gaming system market factors include a relative popularity of each of the two or more games

8. The gaming system of claim 1, wherein a commission is charged to the one or more players each time the two or more exchangeable gaming currencies are converted from one form to another form.

9. A computer enabled gaming market comprising:
two or more games to be played by one or more players, each game configured to enumerate a number of points earned through play of the respective two or more games; and
wherein points of one of the two or more games are exchangeable for one or both of: commonly recognized monetary units, or equivalent points wherein the equivalent points are considered equivalent in value in the gaming market as if they were earned through play of another of the two or more games.

10. The computer enabled gaming market of claim 9, wherein points of each one of the two or more games are converted into universal points using respective conversion factors

11. The computer enabled gaming market of claim 9, wherein the points of one of the two or more games are exchangeable between two players.

12. The computer enabled gaming market of claim 9, wherein the points of the one of the two or more games are exchangeable between one player and an administrator of the gaming market.

13. The computer enabled gaming market of claim 9, wherein a commission is charged to the one or more players each time points are exchanged.

14. The computer enabled gaming market of claim 9, wherein the commission is between 0.01% and 5.00%.

15. The computer enabled gaming market of claim 9, wherein the commission is 1%.

16. A method of forming a gaming system comprising:
providing two or more games to be played, the two or more games configured such that players of any of the two or more games can earn points for completing predetermined actions while playing one or more of the two or more games; and
facilitating an exchange between a first player of at least one of the two or more games and one or both of a gaming system administrator and a second player, wherein the exchange includes exchanging one or both of:
commonly recognized monetary units, and
points earned through play of one of the two or more games, or equivalent points wherein the equivalent points are considered equivalent in value in the gaming system as if they were earned through play of another of the two or more games.

17. The method of claim 16, wherein the facilitating an exchange includes transferring the commonly recognized monetary units into a player account, or out of a player account.

18. The method of claim 16, further comprising accepting, from the first and/or second player, a commission for facilitating the exchange.

19. The method of claim 16, further comprising determining relative amounts of the points exchanged, or commonly recognized monetary units exchanged, by determining a relative popularity of the game from which the points were earned as compared to the game for which the points were traded.

20. The method of claim 16, further comprising determining an exchange rate for performing the exchanging, the exchange rate determined according to a relative popularity of one game verses another game.
